(19) United States
(12) Patent Application Publication
(10) Pub. No.: US 2010/0017533 A1
(43) Pub. Date: Jan. 21, 2010

(54) METHOD AND APPARATUS FOR REPRODUCING CONTENTS, AND PORTABLE TERMINAL DEVICE

(76) Inventor: Yun-Hee HAN, Osan-si (KR)

Correspondence Address: KED & ASSOCIATES, LLP, P.O. Box 221200, Chantilly, VA, 20153-1200, US

(21) Appl. No.: 12/502,406

(22) Filed: Jul. 14, 2009

(30) Foreign Application Priority Data
Jul. 21, 2008 (KR) 2008-0070727

(51) Int. Cl. G06F 15/16; H04N 5/91

(52) U.S. Cl. 709/231; 386/95; 709/233

(57) ABSTRACT

The present invention relates to a content reproducing apparatus, a method for reproducing contents, and a portable terminal device. The present invention comprises a download module 110 configured to download media contents. The download module 110 comprises a buffer memory 112 configured to store content stream and a rate checking unit 114 checking a current download rate. Further a reproducing module 120 which accesses to the buffer memory 112 and reproduces contents is provided. The reproducing module 120 comprises a determining unit 122 configured to determine whether the currently downloaded content can be seamlessly reproduced at the normal rate, if the rate checking unit 114 detects that the current download rate is lower than the predetermined download rate, a computing unit 124 configured to calculate a reproducing rate to reproduce the content seamlessly, if the determining unit determines that the content cannot be reproduced seamlessly at the normal rate, and a controlling unit 126 configured to allow the content to be seamlessly reproduced at the calculated reproducing rate. According to the present invention, it is advantageous in that media contents downloaded through networks can be stably reproduced.

The present application claims priority from Korean Patent Application No. 10-2008-0070727, filed on Jul. 21, 2008, the subject matter of which is incorporated herein by reference.

### BACKGROUND OF THE INVENTION

1. Field of the Invention

The present invention relates to playing contents, and more specifically to a method and an apparatus for playing contents at a variable rate according to current download rate of the contents and to a terminal device using the same.

2. Description of the Related Art

In the traditional broadcasting environment, contents provided by broadcasting stations are transmitted via a medium such as a terrestrial system, a cable system or a satellite system to a terminal device such as a television, and thus users may watch the received contents. In other words, the traditional broadcasting environment is a one-way analog broadcasting environment.

As the digital broadcasting environment has been established, however, requirements of more various services than that provided by the traditional analog broadcasting environment and of interactive services are on the rise.

Accordingly, several ways to embody the interactive services are being found. Ways, which are recently rising as some of the several ways are Internet protocol television (IPTV) service and video online demand (VOD) service. The IPTV and VOD services allow users to enjoy contents such as a movie or music in real-time without regard to time and place. To provide these services, a content server which transmits pre-stored contents to IP network, and a reproducing device which receives the contents from the IP network and reproduce them on a display apparatus, i.e. a set-top box are required.

Such an above system is operated as follows.

If the IPTV set-top box which is a reproducing device is communicatably connected to the content server, a main menu for searching contents is displayed on the display apparatus. Service users see the main menu and may search and select desired contents using a remote controller. If content is selected, the content server searches the selected content from the content database and transmits the content to the reproducing device in a certain transmission band.

Then, the reproducing device receives the transmitted content and buffers it to a buffer memory periodically. Video stream and/or audio stream included in the content is divided and downloaded to the buffer memory by the capacity of the buffer memory. After an amount of the video stream and/or the audio stream, which is as same as the capacity of the buffer memory is completely downloaded on the buffer memory, the reproducing device transmits the content on the buffer memory to the display apparatus, so that the content may be played.

Here, the transmission of the content from the content server to the reproducing device is accomplished at a rate which is optimized for the network. However, according to the current condition of the network, a situation in which the content is transmitted at a lower rate than the optimized rate may be frequently occurred.

### SUMMARY OF THE INVENTION

It is an object of the present invention to provide a method and an apparatus for normally reproducing media contents even if the network speed is lowered.

To achieve these and other advantages and in accordance with the object of the present invention, as embodied and broadly described herein, the present invention provides in one aspect a media content reproducing apparatus comprising a downloading module configured to download media content; and a reproducing module configured to reproduce currently downloaded content at a lower rate than a normal rate, if a current download rate of the downloading module is lower than a predetermined download rate.

In addition, the download module may comprise a buffer memory having a certain capacity and configured to store currently downloaded content; and a rate checking unit configured to detect the current download rate of the downloading module.

Here, the reproducing module may comprise a determining unit configured to determine whether the currently downloaded content can be seamlessly reproduced at the normal rate, if the rate checking unit detects that the current download rate is lower than the predetermined download rate; a computing unit configured to calculate a reproducing rate to reproduce the content seamlessly, if the determining unit determines that the content cannot be reproduced seamlessly at the normal rate; and a controlling unit configured to allow the content to be seamlessly reproduced at the calculated reproducing rate.

Moreover, the calculated reproducing rate may be lower than the normal rate.

In this case, the computing unit may calculate the reproducing rate based on a remained capacity of total capacity of the buffer memory and on the current download rate.

Further, the controlling unit may allow the content to be reproduced at the normal rate, if the current download rate is the same as or more than the predetermined download rate.

Meanwhile, the present invention provides in another aspect a portable terminal device comprising such download module and such reproducing module as described above.

Here, the reproducing module may comprise a determining unit configured to determine whether the currently downloaded content can be seamlessly reproduced at the normal rate, if the current download rate is lower than the predetermined download rate; a computing unit configured to calculate a reproducing rate to reproduce the content seamlessly, if the determining unit determines that the content cannot be reproduced seamlessly at the normal rate; and a controlling unit configured to allow the content to be seamlessly reproduced at the calculated reproducing rate, wherein the controlling unit allows the content to be reproduced at the normal rate, if the current download rate may be the same as or more than the predetermined download rate.

Further the present invention provides in another aspect a media content reproducing apparatus comprising a rate checking unit configured to detect a current download rate of a content transmitted from a content server; a determining unit configured to determine reproducing state of the content based on the current download rate; and a controlling unit configured to calculate a reproducing rate for the content based on a remained capacity of a memory on which the content is downloaded and stored and on the current download rate, and to seamlessly reproduce the content at the calculated reproducing rate.

In addition, the present invention provides in another aspect a method for reproducing media contents comprising downloading a content; checking a current download rate of the content; and reproducing the content at a reduced rate than a normal rate, if the current download rate is lower than a predetermined rate.

In this case, the method may further comprise reproducing the content at the normal rate, if the current download rate is the same as or more than the predetermined rate.

Moreover, the reduced rate may be calculated by reducing a current reproducing rate from the normal rate, based on a remained capacity of a memory on which the content is downloaded and stored and on the current download rate.

The present invention also provides in another aspect a method for reproducing media contents comprising downloading a content from a content server to a buffer memory of a reproducing device; reading and reproducing the content form the buffer memory at a normal rate and checking a current download rate; determining whether the content can be seamlessly reproduced at a current reproducing rate, if the current download rate is lower than a predetermined rate, based on the checking; calculating a reproducing rate at which the content can be seamlessly reproduced, if the reproduction of the content is expected not to be seamlessly reproduced; and reproducing the content at the calculated reproducing rate.

Here, the method may further comprise reproducing the content at the normal rate, if the current download rate is recovered to the same as or more than the predetermined rate.

In addition, in the determining step, whether the content can be seamlessly reproduced may be determined based on a remained capacity of the buffer memory of a reproducing device and the current download rate, and in the calculating step, the reproducing rate may be calculated based on the remained capacity of the buffer memory of a reproducing device and the current download rate.

As described above in detail, in the method and the apparatus for reproducing media contents, the following advantages can be expected.

That is, in a system in which media contents are downloaded and at the same time reproduced (in other words, media contents are streamed), a reproducing rate of content is reduced in a case where a download rate for downloading a content from a content server is lowered such that time for downloading the content is earned and the content can be seamlessly reproduced, if it is determined to be difficult to reproduce the content at a current reproducing rate. And thus it is possible to be prevented that content reproduction is discontinued for a moment when the download rate is low.

Therefore, users can watch or listen to media contents seamlessly without regard to a download rate of contents.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram showing the configuration of a system including a media contents reproducing apparatus according to an embodiment of the present invention;

FIG. 2 is a flow chart showing a method for reproducing contents according to an embodiment of the present invention;

FIG. 3 is an illustration showing an embodiment in which a content reproducing apparatus according to an embodiment of the present invention is configured in a terminal device and a media content is being reproduced.

### DETAILED DESCRIPTION OF THE INVENTION

Hereinafter, a specific embodiment of a content reproducing apparatus and method according to the present invention will be described in detail with reference to the accompanying drawings.

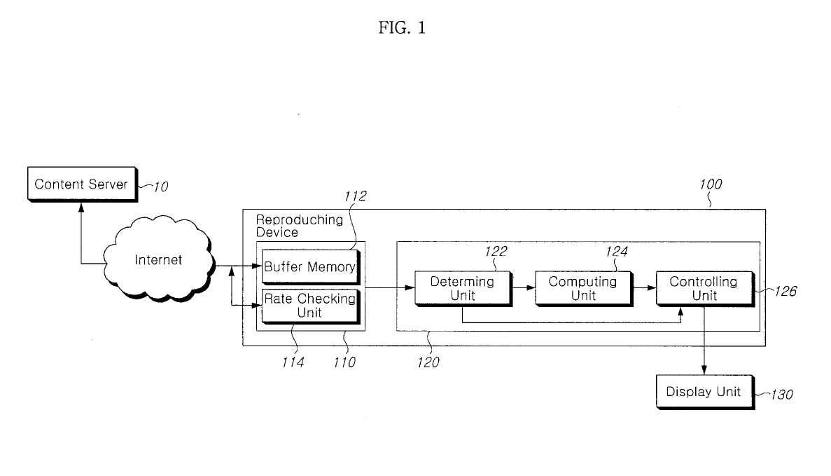

FIG. 1 is a block diagram showing the configuration of a system including a media content reproducing apparatus according to an embodiment of the present invention.

As shown in FIG. 1, a content server 10 storing media contents is provided in the system.

In addition, the media content reproducing apparatus 100 is provided with a download module 110 which downloads media contents from the content server 10. The download module 110 includes a buffer memory 112 having an amount of capacity. Video stream and/or audio stream (hereinafter, ‘content stream’) is downloaded to the buffer memory 112 by the capacity of the buffer memory 112, and then transmitted to a reproducing module 120 which will be described below.

In general, it is called ‘buffering’ that content stream is stored to the buffer memory 112. When the buffering is finished and thus there is no capacity to store content stream in the buffer memory 112, the download module 110 transmits the content stream from the buffer memory 112 to the reproducing module 120 and the reproducing module 120 reproduces the content.

Furthermore, a rate checking unit 114 which measures a current download rate of the content stream downloaded from the content server 10 is provided in the download module 110. Download rate is predetermined in principle as a rate at which the reproducing module 120 can normally reproduce contents. If too many users connect to the content server 10 at the same time or if the network encounters an error, however the current download rate may be lower than the predetermined rate.

Next, a reproducing module 120 receiving content stream from the buffer memory 112 and reproducing content on a display unit 130 is provided in the content reproducing apparatus 100. The reproducing apparatus 100 comprises a determining unit 122 which determines whether the content currently being downloaded can be reproduced normally or not, based on the current download rate measured by the rate checking unit 114 of the download module 110. That is, the determining unit 122 determines whether the current download rate is lowered below a predetermined download rate and thus the content cannot be expected to be seamlessly reproduced if the content is reproduced at a normal rate which is predetermined. The determination is conducted based on a remained capacity, which is not occupied with the content data, of total capacity of the buffer memory and on the current download rate.

Moreover, the reproducing module 120 comprises a computing unit 124 configured to calculate a reproducing rate at which the content can be reproduced seamlessly (hereinafter, ‘reduced rate) if the content cannot be expected to be seamlessly reproduced as a result of the determination of the determining module 122, wherein the reduced rate is reduced from the normal rate. The reproduced rate is calculated based on the remained capacity, which is not occupied with the content data, of total capacity of the buffer memory and on the current download rate. For example, if the normal rate is the rate of one time, the reduced rate may be a rate of 0.8 to 0.9 times.

Further, the reproducing module 120 comprises a controlling unit 126 configured to reproduce the content on the display unit 130 at the normal rate and to reproduce at the reduced rate which is calculated by the computing unit 124, if the content cannot be expected to be seamlessly reproduced at the normal rate. Also, the controlling unit 126 is configured to reproduce the content at the normal rate again, when the current download rate is recovered to the predetermined download rate. Such controlling unit 126 controls the operations of the reproducing apparatus 100 over all. Moreover, though the computing unit 124 and the controlling unit 126 are described as separate elements from each other in this embodiment, but they may be configured as a single element. For example, the controlling unit 126 can be configured to calculate the reduced rate and to reproduce the content.

In addition, the display unit 130 on which the content is reproduced, may be one of CRT (cathode-ray tube), LCD (liquid crystal display), PDP (plasma display panel) and so on.

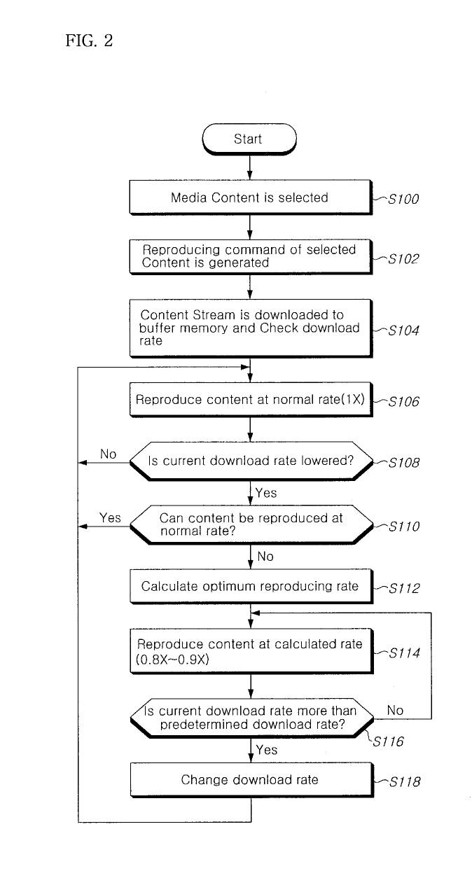

Hereinafter, the operation of the content reproducing apparatus according to the present invention as described above will be described in detail with reference to the FIG. 2.

FIG. 2 is a flow chart showing a method for reproducing contents according to an embodiment of the present invention.

Firstly, if the content server 10 and a reproducing apparatus 100 are connected to each other through the Internet, a service user operates the reproducing apparatus 100 and selects a media content which he desires to play among the contents stored in the content server (S100). Then the selected content becomes on standby. At this state, a content reproducing command is generated in order to reproduce the selected content (S102). The content reproducing command is generated by input operation of the service user using such as input buttons and transmitted to the content server 10.

Then, in the step 104 (S104), the content server 10 starts transmitting the selected content. Here, the content is transmitted as content stream. The content stream is transmitted from the content server 10 to the reproducing apparatus 100. The download module 110 of the reproducing apparatus 100 receives the content stream by the capacity of the buffer memory 112 at a time. The buffering is conducted until the buffer memory 112 is filled up with the content. During the buffering, the content stored in the buffer memory is not reproduced. At this time, the rate checking unit 114 starts checking the current download rate.

If the content stream is downloaded by the capacity of the buffer memory 112 from the content server, the controlling unit 126 reads the content data on the buffer memory 112 according to the order in which the content data are stored on the buffer memory, and reproduces the content on the display unit 130 (S106). The content is reproduced at the normal rate. Then, the buffer memory 112 gets empty as much as the capacity of the reproduced content data and the content continues to be downloaded and stored on the buffer memory 112.

Meanwhile, when the content is reproduced on the display 130 at the normal rate, the rate checking unit 114 continues to check the download rate of the content stream which is currently being downloaded from the content server 10 to the reproducing apparatus 100, and sends the result of checking to the determining unit 122 (S108). In the result, if the current download rate approximates or is more than the predetermined download rate, the controlling unit 126 reproduces the content at the normal rate.

However, the download rate may be lowered, for example when too many users connect to the content server 10 at the same time.

If the current download rate is lowered, the rate checking unit 114 checks the lowered download rate and sends the information to the determining unit 122. Then, the determining unit 122, in the step 110, determines whether the content currently reproduced can be seamlessly reproduced at a current reproducing rate based on the current download rate and a currently remained capacity of total capacity of the buffer memory. If the determining unit 122 determines that the content can be seamlessly reproduced, the controlling unit 126 reproduces the content at the normal rate. On the other hand, if the determining unit 122 determines that the content cannot be seamlessly reproduced at the normal rate under the current download rate, the result of determining is transmitted to the computing unit 124.

Then, the computing unit 124 calculates an optimum reproducing rate at which the currently streaming content can be seamlessly reproduced (S112). The calculated optimum reproducing rate is a value reduced from the normal rate. The reduced rate may be from 0.8 to 0.9 times the normal rate. The computing unit 124 sends the calculated reproducing rate to the controlling unit 126.

The controlling unit 126 reproduces the content at the calculated reproducing rate reduced from the normal rate on the display unit 130 (S114). For example, the controlling unit 126 reproduces the content at from 0.8 to 0.9 times the normal rate.

Accordingly, the download module 110 can be sure of time to download content stream from the content server 10 as long as the reproducing rate is reduced, and thus the reproducing module 120 can reproduce the content seamlessly, even if the download rate gets down.

On this wise, the controlling unit 126 reproduces the content at a reduced rate and at the same time, the rate checking unit 114 continues to check the current download rate at which the content stream is currently being downloaded to the download module 110. At this time, if the checked download rate is recovered to the predetermined download rate (S116), the controlling unit 126 adjusts the reproducing rate from a reduced rate to the normal rate (S118). Here, the predetermined download rate is a rate at which the content stream can be downloaded from the content server 10 to the download module 110 so that the content can be reproduced at the normal rate.

Meanwhile, the reproducing apparatus 100 may be an apparatus which is hard to carry, such as IPTV set-top box. In this case, the content server 10 and the reproducing apparatus 100 can be connected to each other by cable. However, the reproducing apparatus 100 may also be a portable terminal which is connected to the content server 10 by wireless and downloads and reproduces contents.

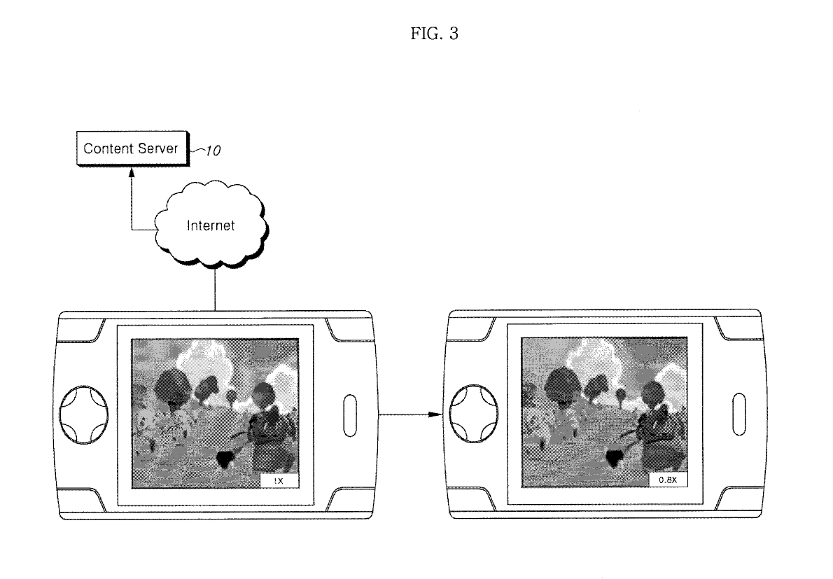

In FIG. 3, an embodiment in which the content reproducing apparatus according to the present invention is provided in a portable terminal device and is reproducing content is illustrated. The portable terminal device may be a device being able to reproduce contents even when it is moving, such as a cellular phone, a portable multimedia player, or a navigator. The portable terminal device comprises the download module and the reproducing module which configure the content reproducing apparatus of an embodiment of the present invention.

In addition, as shown in FIG. 3, the current reproducing rate is indicated on the display of the portable terminal device. That is, FIG. 3 illustrates an example that a content which was being reproduced at 1 time the normal rate on the portable terminal device is reproduced at 0.8 times the normal rate after the download rate got down. The portable terminal, of course, may not indicate the current reproducing rate on the display.

The scope of the present invention is not limited to the embodiments described above but is defined by the appended claims. It will be apparent that those skilled in the art can make various modifications and changes thereto within the scope of the invention defined by the claims.

What is claimed is:

1. A media content reproducing apparatus comprising:
a downloading module configured to download media content; and
a reproducing module configured to reproduce downloaded content at a lower rate than a normal rate, if a current download rate of the downloading module is lower than a predetermined download rate.

2. The apparatus as claimed in claim 1, wherein the download module comprises:
a buffer memory configured to store currently downloaded content; and
a rate checking unit configured to detect the current download rate of the downloading module.

3. The apparatus as claimed in claim 2, wherein the reproducing module comprises:
a determining unit configured to determine whether the downloaded content can be seamlessly reproduced at the normal rate, if the rate checking unit detects that the current download rate is lower than the predetermined download rate;
a computing unit configured to calculate a reproducing rate to reproduce the content seamlessly, if the determining unit determines that the content cannot be reproduced seamlessly at the normal rate; and
a controlling unit configured to allow the content to be seamlessly reproduced at the calculated reproducing rate.

4. The apparatus as claimed in claim 3, wherein the calculated reproducing rate is lower than the normal rate.

5. The apparatus as claimed in claim 3, wherein the computing unit calculates the reproducing rate based on a remained capacity of total capacity of the buffer memory and on the current download rate.

6. The apparatus as claimed in claim 3, wherein the controlling unit allows the content to be reproduced at the normal rate, if the current download rate is the same as or more than the predetermined download rate.

7. A portable terminal device comprising:
a downloading module configured to download media content; and
a reproducing module configured to reproduce downloaded content at a lower rate than a normal rate, if a current download rate of the downloading module is lower than a predetermined download rate,
wherein the download module comprises a buffer memory configured to store currently downloaded content and a rate checking unit configured to detect the current download rate of the downloading module.

8. The device as claimed in claim 7, wherein the reproducing module comprises:
a determining unit configured to determine whether the currently downloaded content can be seamlessly reproduced at the normal rate, if the current download rate is lower than the predetermined download rate;
a computing unit configured to calculate a reproducing rate to reproduce the content seamlessly, if the determining unit determines that the content cannot be reproduced seamlessly at the normal rate; and
a controlling unit configured to allow the content to be seamlessly reproduced at the calculated reproducing rate,
wherein the controlling unit allows the content to be reproduced at the normal rate, if the current download rate is the same as or more than the predetermined download rate.

9. A media content reproducing apparatus comprising:
a rate checking unit configured to detect a current download rate of a content transmitted from a content server;
a determining unit configured to determine reproducing state of the content based on the current download rate; and
a controlling unit configured to calculate a reproducing rate for the content based on a remained capacity of a memory on which the content is downloaded and stored and on the current download rate, and to seamlessly reproduce the content at the calculated reproducing rate.

10. A method for reproducing media contents comprising:
downloading a content;
checking a current download rate of the content; and
reproducing the content at a reduced rate than a normal rate, if the current download rate is lower than a predetermined rate.

11. The method as claimed in claim 10, further comprising reproducing the content at the normal rate, if the current download rate is the same as or more than the predetermined rate.

12. The method as claimed in claim 10, wherein the reduced rate is calculated by reducing a current reproducing rate from the normal rate, based on a remained capacity of a memory on which the content is downloaded and stored and on the current download rate.

13. A method for reproducing media contents comprising:
downloading a content from a content server to a buffer memory of a reproducing device;
reading and reproducing the content form the buffer memory at a normal rate and checking a current download rate;
determining whether the content can be seamlessly reproduced at a current reproducing rate, if the current download rate is lower than a predetermined rate, based on the checking;
calculating a reproducing rate at which the content can be seamlessly reproduced, if the reproduction of the content is expected not to be seamlessly reproduced; and
reproducing the content at the calculated reproducing rate.

14. The method as claimed in claim 13 further comprising reproducing the content at the normal rate, if the current download rate is recovered to the same as or more than the predetermined rate.

15. The method as claimed in claim 13, wherein whether the content can be seamlessly reproduced is determined based on a remained capacity of the buffer memory of a reproducing device and the current download rate, in the determining step.

16. The method as claimed in claim 13, wherein the reproducing rate is calculated based on the remained capacity of the buffer memory of a reproducing device and the current download rate, in the calculating step.
